(19) United States
(12) Patent Application Publication
(10) Pub. No.: US 2010/0057861 A1
(43) Pub. Date: Mar. 4, 2010

(54) Dynamic Email Recipients Based on Entered Subject

(75) Inventors: Meena Nigam, Belmont, CA (US); Lisa A. Seacat, San Francisco, CA (US)

Correspondence Address: Cantor Colburn LLP - IBM SVL, 20 Church Street, 22nd Floor, Hartford, CT, 06103-3207, US

(73) Assignee: INTERNATIONAL BUSINESS MACHINES CORPORATION, Armonk, NY (US)

(21) Appl. No.: 12/201,393

(22) Filed: Aug. 29, 2008

(51) Int. Cl. G06F 15/82

(52) U.S. Cl. 709/206

(57) ABSTRACT

A method is provided for dynamically inserting email recipients based on entering a subject. A subject is received being typed by a user for an email. The subject being typed is parsed. It is recognized that the subject has been previously stored with corresponding email addresses related to the subject. In response to recognizing that the subject has been previously stored, the previously stored corresponding email addresses that relate to the subject are inserted. The subject and the corresponding email addresses were previously typed by the user, such that the subject and the corresponding email addresses could be stored. The corresponding email addresses are respectively inserted in TO fields, carbon copy (CC) fields, and/or blind carbon copy (BCC) fields of the email in accordance with a manner in which the corresponding email addresses were previously typed by the user.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

Exemplary embodiments relate to electronic mail (email), and particularly to assisting users complete recipient information.

2. Description of Background

Electronic mail, often abbreviated to e-mail, email, or simply mail, is a store-and-forward method of writing, sending, receiving and saving messages over electronic communication systems. Today, email is a very popular way of communicating.

Oftentimes a user will reuse subjects while sending emails to the same set of people. This is because the same set of people are usually working with the same topics. Nevertheless, the user has to continuously type the same subjects and emails addresses over again.

Currently, there are no known solutions that recognize a subject and auto-populate potential recipients.

### SUMMARY OF EXEMPLARY EMBODIMENTS

In accordance with exemplary embodiments, a method is provided for dynamically inserting email recipients based on an entered subject. A subject is received by being typed by a user for an email. The subject being typed is parsed. It is recognized that the subject has been previously stored with corresponding email addresses related to the subject. In response to recognizing that the subject has been previously stored, the previously stored corresponding email addresses that relate to the subject are inserted. The subject and the corresponding email addresses were previously typed by the user, such that the subject and the corresponding email addresses could be stored. The corresponding email addresses are respectively inserted in TO fields, carbon copy (CC) fields, and/or blind carbon copy (BCC) fields of the email in accordance with a manner in which the corresponding email addresses were previously typed by the user.

System and computer program products corresponding to the above-summarized methods are also described herein.

Additional features and advantages are realized through the techniques of exemplary embodiments. Exemplary embodiments of the invention are described in detail herein and are considered a part of the claimed invention. For a better understanding of features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features are apparent from the following detailed description taken in conjunction with the accompanying drawings in which:

FIG. 1 illustrates an example of a computer having capabilities, which may be utilized by exemplary embodiments;

FIG. 2 illustrates a system which may be utilized to implement exemplary embodiments;

FIG. 3 illustrates an email screen;

FIG. 4 illustrates auto-population in accordance with exemplary embodiments;

FIG. 5 illustrates an email screen in accordance with exemplary embodiments.

FIG. 6 illustrates a process for associating an entered subject with email addresses in accordance with exemplary embodiments;

FIG. 7 illustrates a process for dynamically inserting email recipients based on entering a subject in accordance with exemplary embodiments; and

FIG. 8 illustrates a method for dynamically inserting email recipients based on entering a subject in accordance with exemplary embodiments.

The detailed description explains exemplary embodiments, together with features, by way of example with reference to the drawings.

### DETAILED DESCRIPTION OF EXEMPLARY EMBODIMENTS

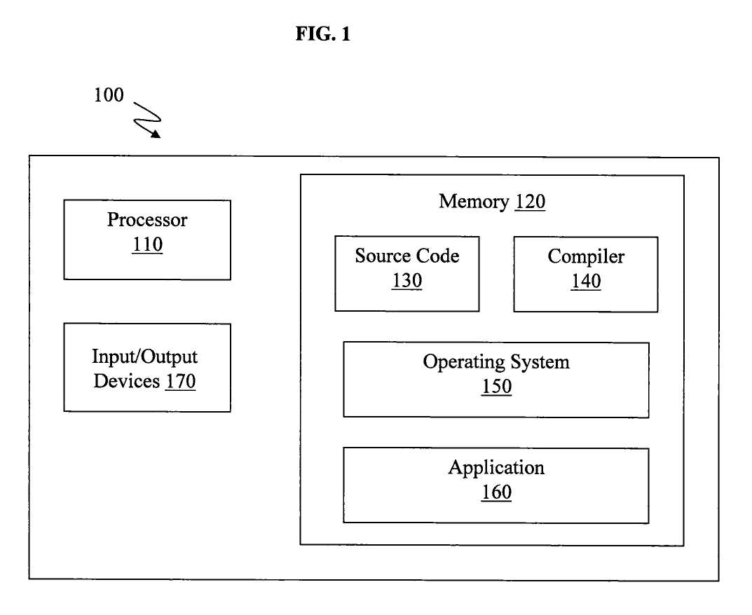

FIG. 1 illustrates an example of a computer 100 having capabilities, which may be utilized by exemplary embodiments. Various operations discussed above may also utilize the capabilities of the computer 100. One or more of the capabilities of the computer 100 may be incorporated in any element, module, application, and/or component discussed herein.

The computer 100 includes, but is not limited to, PCs, workstations, laptops, PDAs, palm devices, servers, storages, and the like. Generally, in terms of hardware architecture, the computer 100 may include one or more processors 110, memory 120, and one or more input and/or output (I/O) devices 170 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 110 is a hardware device for executing software that can be stored in the memory 120. The processor 110 can be virtually any custom made or commercially available processor, a central processing unit (CPU), a data signal processor (DSP), or an auxiliary processor among several processors associated with the computer 100, and the processor 110 may be a semiconductor based microprocessor (in the form of a microchip) or a macroprocessor.

The memory 120 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 120 may incorporate electronic, magnetic, optical, and/or other types of storage media. Note that the memory 120 can have a distributed architecture, where various components are situated remote from one another, but can be accessed by the processor 110.

The software in the memory 120 may include one or more separate programs, each of which comprises an ordered listing of executable instructions for implementing logical functions. The software in the memory 120 includes a suitable operating system (O/S) 150, compiler 140, source code 130, and one or more applications 160 in accordance with exemplary embodiments. As illustrated, the application 160 comprises numerous functional components for implementing the features and operations of the exemplary embodiments. The application 160 of the computer 100 may represent various applications, computational units, logic, functional units, processes, operations, virtual entities, and/or modules in accordance with exemplary embodiments, but the application 160 is not meant to be a limitation.

The operating system 150 controls the execution of other computer programs, and provides scheduling, input-output control, file and data management, memory management, and communication control and related services. It is contemplated by the inventors that the application 160 for implementing exemplary embodiments may be applicable on all commercially available operating systems.

The application 160 may be a source program, executable program (object code), script, or any other entity comprising a set of instructions to be performed. When a source program, then the program is usually translated via a compiler (such as the compiler 140), assembler, interpreter, or the like, which may or may not be included within the memory 120, so as to operate properly in connection with the O/S 150. Furthermore, the application 160 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 170 may include input devices such as, for example but not limited to, a mouse, keyboard, scanner, microphone, camera, etc. Furthermore, the I/O devices 170 may also include output devices, for example but not limited to a printer, display, etc. Finally, the I/O devices 170 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 170 also include components for communicating over various networks, such as the Internet or intranet.

If the computer 100 is a PC, workstation, intelligent device or the like, the software in the memory 120 may further include a basic input output system (BIOS) (omitted for simplicity). The BIOS is a set of essential software routines that initialize and test hardware at startup, start the O/S 150, and support the transfer of data among the hardware devices. The BIOS is stored in some type of read-only-memory, such as ROM, PROM, EPROM, EEPROM or the like, so that the BIOS can be executed when the computer 100 is activated.

When the computer 100 is in operation, the processor 110 is configured to execute software stored within the memory 120, to communicate data to and from the memory 120, and to generally control operations of the computer 100 pursuant to the software. The application 160 and the O/S 150 are read, in whole or in part, by the processor 110, perhaps buffered within the processor 110, and then executed.

When the application 160 is implemented in software it should be noted that the application 160 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 160 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 160 is implemented in hardware, the application 160 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

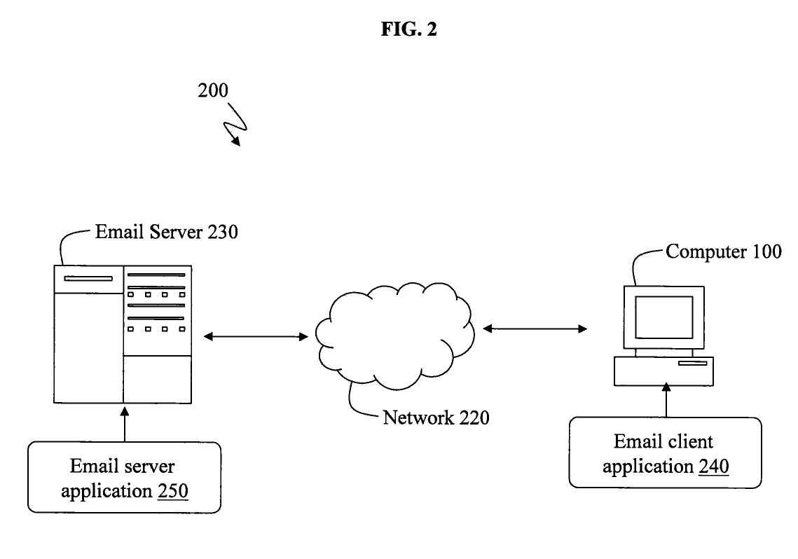

FIG. 2 illustrates a system 200 which may be utilized to implement exemplary embodiments. The system 200 is for illustrative purposes only and is not meant to be limiting. The system 200 includes one or more computers 100, which is operatively connected to a network 220 (such as the Internet). The computer 100 can operatively connect to one or more email servers 230 via the network 220. The email server 230 is a computing device and may include any of the features discussed herein for the computer 100 and more. The computer 100 may include an email client application 240 and the email server 230 may include an email server application 250. The email client application 240 and the email server application 250 may include any of the features of the application 160 and more. The email client application 240 and the email server application 250 interact to provide email services for a user of the computer 100, as understood by one skilled in the art. The email server 230 and the computer 100 can operatively communicate with other email servers and computers to transmit and receive emails. Further, the email server 230 and the computer 100 may include or be operatively connected to databases for storing information as discussed herein according to exemplary embodiments.

Additionally, the network 220 may include circuit-switched and/or packet-switched technologies and devices, such as routers, switches, hubs, gateways, etc., for facilitating communications. The network 220 may include wireline and/or wireless components utilizing, e.g., IEEE 802.11 standards for providing over-the-air transmissions of communications. The network 220 can include IP-based networks for communication between a customer service center and clients/users. The network 220 can be representative of countless networks.

In exemplary embodiments, the network 220 can be a managed IP network administered by a service provider, which can control bandwidth and quality of service for the communications discussed herein. The network 220 may be implemented in a wireless fashion, e.g., using wireless protocols and technologies, such as WiFi, WiMax, BLUETOOTH, etc. The network 220 can also be a packet-switched network as a local area network, a wide area network, a metropolitan area network, an Internet network, or other similar types of networks. The network 220 may be a cellular communications network, a fixed wireless network, a wireless local area network (LAN), a wireless wide area network (WAN), a personal area network (PAN), a virtual private network (VPN), an intranet or any other suitable network, and the network 220 may include equipment for receiving and transmitting signals, such as a cell tower, a mobile switching center, a base station, and a wireless access point.

Furthermore, exemplary embodiments are not limited to but are capable of being implemented in the system 200 illustrated in FIG. 2. Additionally, the server 230 may be representative of numerous servers. The computer 100 may be representative of numerous computing devices. Therefore, the system 200 illustrated in FIG. 2 is neither limited numerically to the elements depicted therein nor limited to the exact configuration and operative connections of elements. Further, it is understood by those skilled in the art that elements may be added to, subtracted from, or substituted for the elements described in FIG. 2.

Exemplary embodiments provide a mechanism to dynamically populate email TO, CC, and BCC fields based on a typed subject of an email.

When a user types in a subject, body, and TO, CC, and BCC fields of an email as with normal email operations, the email client application 240 stores this information. The information may be contained in databases stored in memory (such as the memory 120) of the server 230 and/or the computer 100. The email client application 240 stores such information about past email habits for later use. For example, a user may usually type the subject “Fish Sticks” when sending an email to Sue (email address) and Joe (email address). In accordance with exemplary embodiments, the email client application 240 (and/or the email server application 250) is configured to recognize that every time the subject “Fish Sticks” is typed the user sends an email to Sue and Joe, and this information is remembered by the email client application 240 and/or the email server application 250.

As the user types a recognized/stored subject, the email addresses in TO, CC, or BCC fields continually change to reflect possible included recipients in accordance with exemplary embodiments. For example, if the user types a particular recognized subject, the email client application 240 and/or the email server application 250 auto-populates the TO, CC, or BCC fields by inserting respective recipients. However, if the user erases the subject or types additional information in the subject, the email client application 240 and/or the email server application 250 are configured to modify the TO, CC, and BCC fields accordingly.

Also, in accordance with exemplary embodiments, when the user has finished typing the subject the user may manually edit the lists by deleting/adding additional recipients. For example, there may be similarly stored subjects, such as “School” and “School work”, and the “School” may have its related recipients while “the subject “School work” has it related recipients. If the subject “School” is typed as the subject, in one implementation, the email client application 240 and/or the email server application 250 can be configured to list recipients for both the subject “School” and the subject “School work”. The user can then manually delete the unwanted recipients. Also, the user can set user preferences so that the email client application 240 and/or the email server application 250 will only input recipients when there is an exact match or partial match. For example, the user preferences can be set for a match of words but not require a complete match for an entire phrase, or the user preferences can require a complete match of the entire phrase. The user preferences can be set to match roots of words even though the ending or beginning may be different. Indeed, the user preferences (e.g., a module) of the email client application 240 and/or the email server application 250 has various options which can be set as desired, thus giving the user a wide array of choices.

Below, an example is to illustrate features of exemplary embodiments. FIG. 3 illustrates an email screen 300. In FIG. 3, a user may open a normal email screen 300, which includes fields 305, 310, 315, and 320. A user may type “Hello Peter” in the subject field 320.

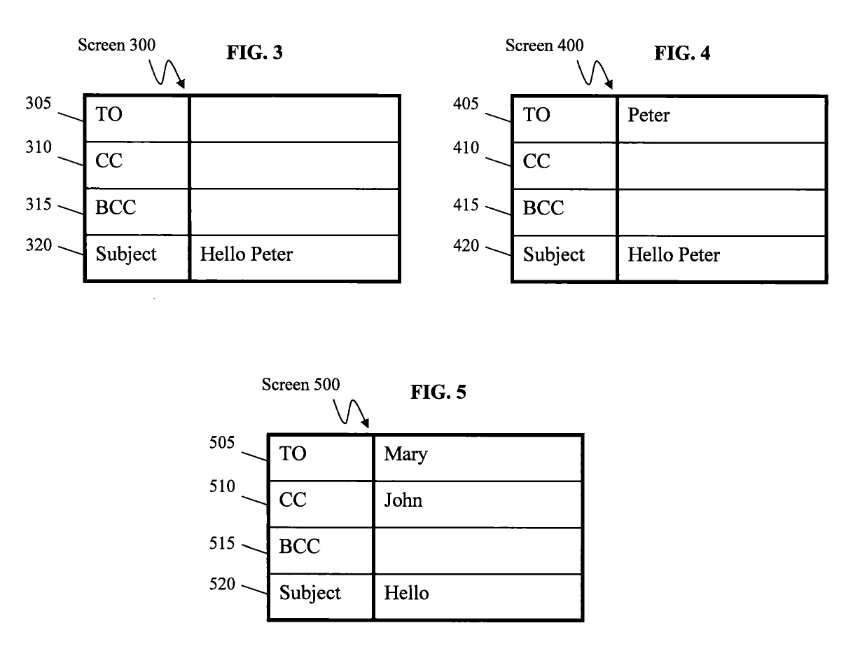

The email client application 240 and/or the email server application 250 has previously stored recipients for the subject “Hello Peter”. FIG. 4 illustrates an email screen 400 and shows fields 405, 410, 415, and 420. FIG. 4 illustrates auto-population in accordance with exemplary embodiments. As the user types, possible recipients rotate through the fields 405, 410, and 415. In response to the user typing the subject “Hello Peter” in the subject field 420, the email client application 240 and/or the email server application 250 inserts (auto-populates) the corresponding recipient “Peter” in the TO field 405. Note that the user did not type Peter's email address in the TO field 405 but instead the stored subject was recognized and the TO field was auto-populated according to exemplary embodiments.

FIG. 5 illustrates an email screen 500 and shows fields 505, 510, 515, and 520 in accordance with exemplary embodiments. FIG. 5 illustrates how auto-population adapts to correspond with changes in the subject field 520 in accordance with exemplary embodiments. From FIG. 4, the user has typed in the subject “Hello Peter”, and the email client application 240 and/or the email server application 250 auto-populated the email address for “Peter”. However, if the user deletes the subject or parts of the subject, if the user adds more to the subject, or if the user modifies the parts of the subject, the recipient fields 505, 510, and 515 update accordingly. For example, the user may delete “Peter” from “Hello Peter” in the subject field 520. Accordingly, the TO field 505 automatically updates to show the email address for “Mary”, and the CC field 510 automatically updates to show the email address for “John”. In accordance with exemplary embodiments, auto-population is based on the subject entered by the user.

Although specific examples have been shown, it is understood that the examples are for illustrative purposes only and are not meant to be limiting. Indeed, as the user types in the subject field 520, numerous possible recipient options can rotate through the TO, CC, and BCC fields 505, 510, and 515 respectively. For the sake of clarity, the rotating of each possible recipient is not shown in FIG. 5.

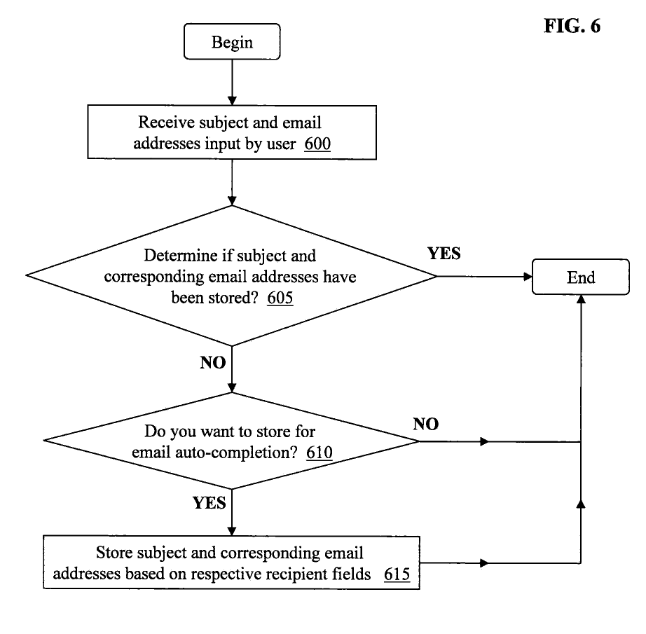

FIG. 6 illustrates a process for associating and storing an entered subject with email addresses in accordance with exemplary embodiments.

The email client application 240 and/or the email server application 250 receives the subject and email addresses input by a user at 600.

It is determined (by the email client application 240 and/or the email server application 250) if the subject and corresponding email addresses have been stored at 605. If the subject and corresponding email addresses have already been stored, the process ends.

If the subject and corresponding email addresses have not been stored, the email client application 240 and/or the email server application 250 may ask do you want to store for email auto-population at 610. If the subject and corresponding email addresses are not to be stored, the process ends.

If the subject and corresponding email addresses are to be stored, the email client application 240 and/or the email server application 250 may store the subject and corresponding email addresses based on respective recipient fields at 615, and the process ends. For example, if the user typed recipients in the TO field, then the recipients would be stored in the TO field. If the user typed recipients in the CC field, then the recipients would be stored in the CC field, and so forth.

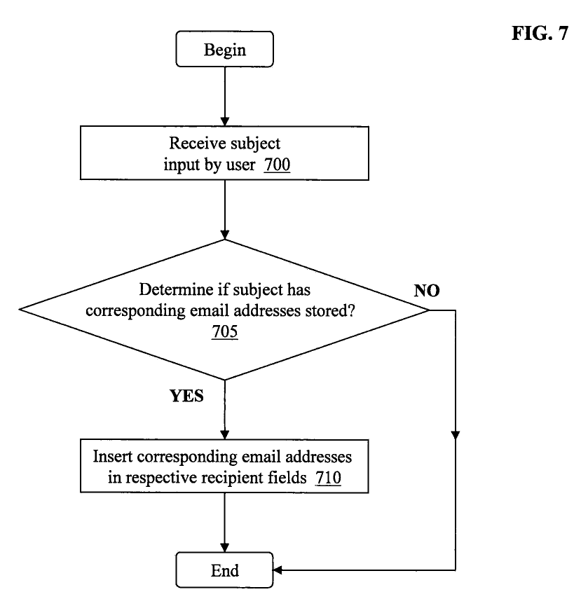

FIG. 7 illustrates a process for dynamically inserting email recipients based on entering a subject in accordance with exemplary embodiments.

The email client application 240 and/or the email server application 250 receives the subject input by user at 700.

It is determined (by the email client application 240 and/or the email server application 250) if subject has corresponding email addresses stored at 705. If the subject does not have corresponding email addresses, the process ends.

The email client application 240 and/or the email server application 250 inserts the corresponding email addresses in respective recipient fields at 710, and the process ends. The email client application 240 and/or the email server application 250 inserts the email addresses for the respective recipients according to how the recipients were originally input by the user for the subject.

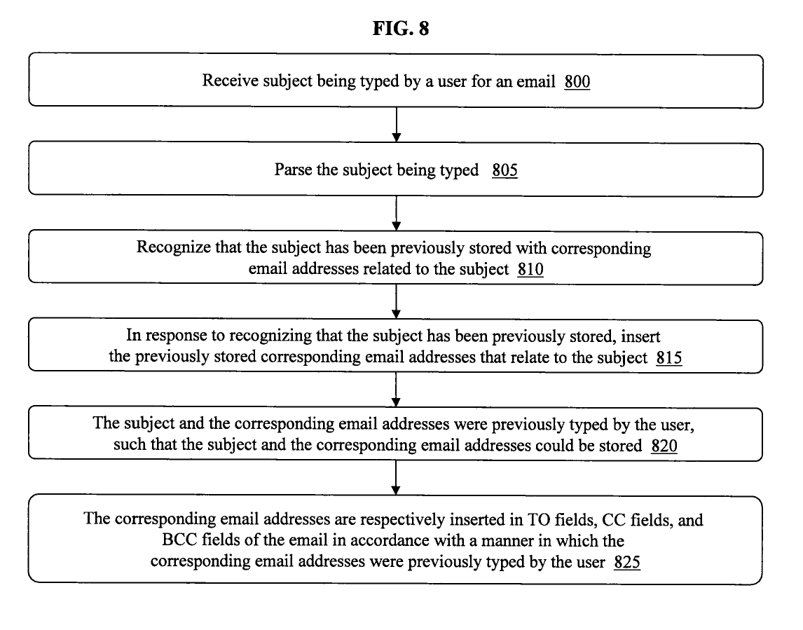

FIG. 8 illustrates a method for dynamically inserting email recipients based on entering a subject in accordance with exemplary embodiments.

The email client application 240 and/or the email server application 250 receives the subject being typed by a user for an email at 800.

The email client application 240 and/or the email server application 250 parses the subject being typed at 805.

The email client application 240 and/or the email server application 250 recognizes that the subject has been previously stored with corresponding email addresses related to the subject at 810.

In response to recognizing that the subject has been previously stored, the email client application 240 and/or the email server application 250 inserts the previously stored corresponding email addresses that relate to the subject at 815.

The subject and the corresponding email addresses were previously typed by the user, such that the subject and the corresponding email addresses could be stored at 820.

The corresponding email addresses are respectively inserted in TO fields, carbon copy (CC) fields, and blind carbon copy (BCC) fields of the email in accordance with a manner in which the corresponding email addresses were previously typed by the user at 825.

Additionally, in exemplary embodiments, the mapping could also be stored on the email server 230. For example, a user may type the subject “WebSphere Demo”, but the user had never typed that subject before. However, people in the user's network (e.g., work intranet) have previously typed the subject “WebSphere Demo”. The email server application 250 of the email server 230 can recognize the subject “WebSphere Demo” and propose (insert) the appropriate recipients, in accordance with exemplary embodiments.

Further, the email server application 250 may include a mail transfer agent (MTA) (also called a mail transport agent, message transfer agent, or smtpd (short for SMTP daemon)), which is a computer program or software agent that transfers electronic mail messages from one computer to another. The email server 230, also called a mail server, can also mean a computer acting as an MTA that is running the appropriate software. The term mail exchanger (MX), in the context of the Domain Name System formally refers to an IP address assigned to a device hosting a mail server, and by extension also indicates the server itself. Various techniques and procedures for transmitting and receiving emails is understood by those skilled in the art.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for dynamically inserting email recipients based on entering a subject, comprising:
receiving subject being typed by a user for an email;
parsing the subject being typed;
recognizing that the subject has been previously stored with one or more corresponding email addresses related to the subject; and
in response to recognizing that the subject has been previously stored, inserting the previously stored one or more corresponding email addresses that relate to the subject;
wherein the subject and the one or more corresponding email addresses were previously typed, such that the subject and the one or more corresponding email addresses could be stored; and
wherein the one or more corresponding email addresses are respectively inserted in at least one of TO fields, carbon copy (CC) fields, and blind carbon copy (BCC) fields of the email in accordance with a manner in which the corresponding email addresses were previously typed.
